(19) United States
(12) Patent Application Publication
(10) Pub. No.: US 2018/0291167 A1
(43) Pub. Date: Oct. 11, 2018

(54) THERMAL EXPANSION COMPOUND FOR HANDLE MOLDING, PREPARATION METHOD AND APPLICATION TECHNOLOGY THEREOF

(71) Applicant: XIAMEN HOWER MATERIAL CO., LTD., Xiamen City (CN)

(72) Inventors: JinYun CAI, Xiamen City (CN); JiangQuan GUAN, Xiamen City (CN); WeiPing LI, Xiamen City (CN); RongQuan XIE, Xiamen City (CN); BuLong LI, Xiamen City (CN)

(21) Appl. No.: 16/004,911

(22) Filed: Jun. 11, 2018

Related U.S. Application Data
(63) Continuation of application No. PCT/CN2017/070727, filed on Jan. 10, 2017.

(30) Foreign Application Priority Data
Feb. 17, 2016 (CN) 201610089002.1

(51) Int. Cl. C08J 9/00; C08J 9/10; C08J 9/36; C08J 9/08; B29C 44/12

(52) U.S. Cl. CPC C08J 9/0066; C08J 9/102; C08J 9/0071; C08J 9/36; C08J 9/105; C08J 9/107; B29K 2105/04; B29C 44/12; C08J 2363/00; C08J 2207/00; C08J 2203/02; C08J 2203/04; C08J 9/08

(57) ABSTRACT

The disclosure discloses a thermal expansion compound for handles, a preparation method, and applications thereof. The thermal expansion compound for handles is prepared by 20-80 wt of thermosetting resin, 5-50 wt of foaming agent, 5-50 wt of stuffing, and 0-60 wt of diluent. The thermal expansion compound for handles applies to the preparation of various sports instruments such as tennis rackets, badminton rackets, squash rackets, PK rackets, beach rackets, flexible rackets, ball bats and clubs. Handles prepared from the thermal expansion compound have an elegant appearance and a good hand feel, avoid secondary expansion during 100-160° C. post-heating treatment, and have a hardness of SHORE D 60-95.

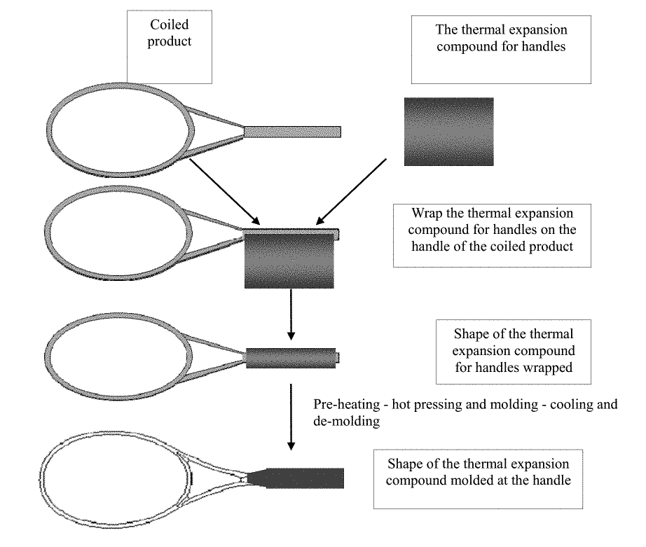

### CROSS-REFERENCE TO RELATED APPLICATIONS

This application is a Bypass Continuation of International Application No. PCT/CN2017/070727, filed Jan. 10, 2017, which claims the benefit of Chinese Patent Application No. 201610089002.1, filed Feb. 17, 2016, all of which are hereby incorporated by reference as if fully set forth herein.

### BACKGROUND OF THE DISCLOSURE

### Technical Field

The disclosure relates to the field of sports instruments, in particular to a thermal expansion compound for handle molding, a preparation method, and applications thereof.

### Description of Related Art

Current handles of tennis rackets, badminton rackets, squash rackets, PK rackets, beach rackets, flexible rackets, ball bats and clubs need to be made of polyurethane PU grip handle form. The production of the handles involves the steps of molding the shape of a rough blank, processing the blank multiple times, placing the processed blank into a foaming mold cavity again, and filling a two-liquid type PU foaming material into the mold cavity by using a filling machine to obtain the required dimensions. The production process has a long flow, a large equipment investment, high energy consumption and a high reject rate. Taking rackets as an example: from preparing raw materials to completing filling, a PU filling procedure requires a relatively long term, usually 3-5 days; equipment needed includes a precision filling machine, an assembly line which runs and heats automatically, a high-pressure air compressor and filling mold cavities of different models and different dimensions; the energy consumption is high, where all heating equipment and machines must run as long as filling is in process; restrained by the equipment and process in the production, 3-5% surface scratches are usually generated, so the reject rate is high, and the repair rate rises, thus resulting in an incremental increase in cost.

Since 2012, inventors Cai Jinyun, et el. disclosed Chinese patents and patent applications 201220387938.X, 201310098800.7, 201320386747.6 and 201220111085.7, related to thermal expansion compounds. The patent application CN201220387938.X discloses a carbon-fiber thermal expansion compound structure, comprising a light structural layer, a plurality of thermal expansion compound coatings which are covered on the light structural layer and are able to provide expansion power by foaming, and a protective layer which is covered on the thermal expansion compound coatings. The patent application CN201320386747.6 discloses a carbon-fiber thermal expansion compound structure, comprising a plastic film carrier, a thermal expansion compound coating which is coated on the plastic film carrier and is able to provide expansion power by foaming, and a flocking layer which is positioned on the thermal expansion compound coating. The patent application CN201220111085.7 discloses a bracket arch structure, comprising a carbon yarn outer layer, a PU support internally disposed in a middle of the carbon yarn outer layer, and expanding polystyrene foam which is filled between the PU support and the carbon yarn outer layer. The above-mentioned structures all protect the thermal expansion compound structure. The Chinese patent ZL201310098800.7 discloses a formula for a thermal expansion compound. The formula comprises the following ingredients: 15-25 weight parts of thermoplastic rubber, 10-25 weight parts of ethyl acetate, 6-20 weight parts of foaming agent, 30-60 weight parts of butanone, 0.5-3 weight parts of plasticizer, 0.5-2.5 weight parts of age resister, 0.5-2 weight parts of stearic acid, 2-3.5 weight parts of cross-linking agent and 3-10 weight parts of polyester fiber. The obtained thermal expansion compound can enhance the strength and toughness of products and add a damping function. Under a heating condition, the thermal expansion compound is able to foam and expand by 40-80 times; however, the operating performance is expected to be improved, and after expanding, surfaces of the manufactured products are seriously dusty, endangering environmental health; besides, molded fiber composite products usually undergo a 80-150° C. post-heating treatment process, and the thermal expansion compound product generates secondary uncontrollable expansion during the post-heating process, resulting in breakage and scrapping of the manufactured products. Therefore, the reject rate rises.

### BRIEF SUMMARY OF THE DISCLOSURE

The objective of the disclosure is to provide a special novel thermal expansion compound for handles, which is integrally molded and avoids secondary expansion during the post-heating process.

In order to achieve the above objectives, the disclosure provides a thermal expansion compound for handles, characterized by being prepared from the following ingredients by weight part:
thermosetting resin: 20-80;
foaming agent: 5-50;
stuffing: 5-50;
diluent: 0-60.

Further, the thermal expansion compound for handles is prepared from the following ingredients by weight part:
thermosetting resin: 30-50;
foaming agent: 20-40;
stuffing: 10-30;
diluent: 0-30.

Further, the thermosetting resin is high-Tg (glass-transition temperature) thermosetting resin at a temperature of 120-350° C.

Further, an expansion temperature of the foaming agent is 50-180° C.

Further, the stuffing is carbon fiber powder, graphite powder, carbon nano-tube, aluminum oxide, magnesium oxide, calcium carbonate or talcum powder.

Further, the diluent is a reaction-type diluent or non-reaction-type diluent;

preferably, the reaction-type diluent is butyl glycidyl ether, phenyl glycidyl ether, C12-14 aliphatic polyalcohol glycidyl ether, or 1,4-butanediol diglycidyl ether;

the non-reaction-type diluent is acetone, butanone, xylene, ethyl acetate, or butyl acetate.

Further, the thickness of the thermal expansion compound for handles is 0.4-10mm, preferably 2-5 mm.

Further, a preparation method includes the following steps: adding the thermosetting resin into the diluent, blending the mixed materials, adding the foaming agent and the stuffing in turn to obtain a mixture, stirring the mixture well, coating the mixture on a backing material; or heating the thermosetting resin until the temperature exceeds a softening temperature, adding the foaming agent and the stuffing to obtain a mixture, stirring the mixture well, and coating the mixture on a backing material; where a proper drying method is adopted according to the existence of the solvent, and cutting dimensions depend on the actual situations;

preferably, the backing material is non-woven fabric, glass fiber felt, pearl cotton or cotton cloth.

The disclosure also discloses applications of the thermal expansion compound for handles to the preparation of handles; preferably, the handles are handles of tennis rackets, badminton rackets, squash rackets, PK rackets, beach rackets, flexible rackets, ball bats and clubs.

A process adopted for preparing handles includes the following procedures:

designing specifications and dimensions according to respective structures of sports instruments, cutting a piece of fiber composite fabric and the thermal expansion compound for handles, sorting the cut pieces for later use;

coiling: coiling the fiber composite fabric according to the structure of a specific sports instrument;

pre-molding: placing the coiled fabric at a heating platform at a temperature within a range of room temperature -80° C., pre-heating the coiled fabric for 3-60 min, extruding the coiled fabric to remove gases among layers as much as possible, flattening the coiled fabric, cutting the thermal expansion compound to an appropriate size and wrapping the cut pieces around a handle of the instrument, then placing the wrapped product in a pre-forming die, and pre-forming the wrapped product into a pre-designed shape of the pre-forming die;

molding: placing a pre-formed product into a pre-heating oven, pre-heating the pre-formed product at a temperature of 35-75° C. for 3-60min, then taking out the preheated product, placing the preheated product into a molding die, closing a die cover; sending the die into a hot pressing molding platform, heating the thermal expansion compound for handle by the effect of a heating program such that the thermal expansion compound expands and then the handle molding is completed (the thermal expansion compound can be well-bonded with the fiber composite after being molded and expanding, and does not peel), where preferably, the heating program includes the following parameters: 80-180° C. heating temperature, 10-120 min heating time, 80-120 kg/cm² external pressure and 5-15 kg/cm² internal pressure;

cooling and de-molding: sending the die into a cooling platform after molding, cooling the molding die, sending the cooled molding die into a de-molding platform, opening the die and taking out the finished product, where preferably, the cooling program includes the following parameters: 15-45° C. cooling temperature, 3-10 min cooling time, 70-105 kg/cm² and external cooling pressure.

In the above process, the internal pressure may be a wind pressure, or a pressure provided by a thermally expandable material.

The hardness of the thermal expansion compound for handles after curing is SHORE D 60-95.

After undergoing a post-heating treatment at a temperature within the range of 100-160° C. for 10-60 min, the molded handle obtained by the disclosure avoids secondary expansion, keeps the size stable, and has expansion volume power (the ratio of the volume after expansion to the volume before expansion) of less than 1%, preferably less than 0.1%.

The thermosetting resin of the disclosure plays the role of fixing a foaming agent carrier bracket, mainly providing strength and hardness after the thermal expansion compound expands and is molded, and improves the stability of temperature resistance through high Tg. If the content of the thermosetting resin is lower than 20 weight parts, the thermal expansion compound has extremely low strength and hardness after expansion molding, resulting in an insufficient binding force when the product undergoes the high-temperature treatment after being taken out of the die. If the content is higher than 80 weight parts, the ratio of the foaming agent is reduced first, which affects the expansion effect, and then the thermal expansion compound has extremely high hardness after expansion molding, resulting in handles containing such compound have no damping effect. The Tg temperature of the thermosetting resin is required to be selected to be matched with the heat-resistant temperature of a service environment. The thermosetting resin may be stably used if the Tg temperature is greater than or equal to the temperature of a potential service environment.

The foaming agent provides proper expansion power mainly in virtue of its expansion characteristics. If the content of the foaming agent is lower than 5 weight parts, the expansion power is too small and the space of a handle portion may not be filled; if the content is higher than 50 weight parts, the expansion power is too large, so an internal fiber product is extruded to cause an internally depressed deformation and change the symmetry of the product, thus affecting the hand feel and the beating/striking performance of clubs, and another possible result is that the product expands again out of control and then blows out during the high-temperature treatment out of the die. The above problems can be avoided as long as the expansion temperature of the foaming agent is consistent with the temperature of the die.

The diluent in the disclosure plays a main role of adjusting the viscosity of the system, facilitating coating of the thermal expansion compound by various means. If no diluent exists, a hot melt coating approach may be needed; if the diluent is added, a common coating approach is capable of being adopted, but a subsequent solvent drying process may be needed.

The thermal expansion compound for handles of the disclosure is 200-1000 g/m² in weight, preferably 500-600 g/m².

The thermal expansion compound applies to the molding of handles of tennis rackets, badminton rackets, squash rackets, PK rackets, beach rackets, flexible rackets, ball bats and clubs.

The disclosure is different from the process flow of an existing solution in that:

The disclosure:

Product Pre-forming- [symbol] Wrapping of a handle with the thermal expansion compound- [symbol] Molding- [symbol] Polishing- [symbol] Painting- [symbol] Assembling- [symbol] Packaging of a finished product.

Existing solution:

Product pre-molding- [symbol] Molding- [symbol] Polishing- [symbol] Painting- [symbol] Weight adjustment- [symbol] Die installation- [symbol] PU material filling- [symbol] Molding- [symbol] Edging and polishing- [symbol] Assembling- [symbol] Packaging of a finished product.

From the above flows it can be seen that the flow of the disclosure features a simpler process, less equipment, and a higher efficiency in comparison with the flow of the existing solution.

### Advantages

(1) The disclosure replaces the molding process of traditional PU-filled handles, integrally molds handles by using a thermal expansion compound especially for wrapping handles at one time, genuinely realizes continuous production, greatly shortens the processing flow by 3-5 days, and enhances the efficiency by 10-15%.

(2) The thermal expansion compound of the disclosure has 5-20 times of foaming powder to generate a proper pressure, and avoids secondary expansion in the subsequent heating process. The hardness of the molded thermal expansion compound for handles of the disclosure is SHORE D 60-95; after being subsequently heated to a temperature within the range of 100-160° C. for 0-60 min, the molded handle obtained by the disclosure avoids secondary expansion, keeps the size stable, and has expansion volume power (the ratio of the volume after expansion to the volume before expansion) of smaller than 1%, preferably smaller than 0.1%. The experiments in Embodiments 3-5 show that the prepared racket handles avoid secondary expansion when heated to a temperature within the range of 100-160° C., and have a hardness of SHORE D81-90.

(3) The thermal expansion compound for handles of the disclosure is well-bonded with the fiber composite after molding and expansion, and does not peel.

(4) The investment in equipment for traditional PU filling production lines is reduced, and energy consumption is lowered.

(4) Repair is avoided; the reject ratio is reduced by 3-5%; quality stability is enhanced; and the market competitiveness of products is enhanced.

### BRIEF DESCRIPTION OF THE SEVERAL VIEWS OF THE DRAWINGS

The sole FIGURE is a flowchart of a process for preparing a thermal expansion compound for handles of the disclosure into racket handles.

### DETAILED DESCRIPTION OF THE DISCLOSURE

The embodiments of the disclosure are described in detail below. Examples of the embodiments are shown in the sole FIGURE, where the same or similar marks always represent the same or similar elements or elements with the same or similar functions. The Embodiments depicted by the attached drawings are exemplary, used to explain the disclosure only, and cannot be regarded as limits to the disclosure. Unspecified technologies or conditions in the embodiments are subject to the technologies or conditions as described in the literature in the prior art or product manuals. All reagents or instruments without markings from manufacturers are all commercially available conventional products.

In the following embodiments, thermosetting resin is bismaleimide modified epoxy resin.

A foaming agent is an azoic compound, a sulfonyl hydrazine compound, a nitroso compound, calcium carbonate, magnesium carbonate or sodium hydrogen carbonate.

Stuffing is carbon fiber powder, graphite powder, carbon nano-tube, aluminum oxide, magnesium oxide, calcium carbonate or talcum powder.

A diluent is a reaction-type diluent or non-reaction-type diluent; the reaction-type diluent is butyl glycidyl ether, phenyl glycidyl ether, C12-14 aliphatic polyalcohol glycidyl ether, or 1,4-butanediol diglycidyl ether; and the non-reaction-type diluent is acetone, butanone, xylene, ethyl acetate, or butyl acetate.

TABLE 1

| | Ingredients (weight part) in embodiments 1-6 | | | | | |
|---|---|---|---|---|---|---|
| | Embodiment | Embodiment | Embodiment | Embodiment | Embodiment | Embodiment |
| | 1 | 2 | 3 | 4 | 5 | 6 |
| Thermosetting | 20 | 30 | 80 | 60 | 50 | 45 |
| resin | | | | | | |
| Foaming | 8 | 5 | 50 | 40 | 30 | 20 |
| agent | | | | | | |
| Stuffing | 5 | 10 | 30 | 50 | 20 | 40 |
| Diluent | 0 | 20 | 60 | 30 | 15 | 40 |

### Embodiment 1: Preparation of a Thermal Expansion Compound for Handles

Raw materials: See table 1

Preparation method: Bismaleimide modified epoxy resin is heated to a softening temperature; then the foaming agent and the stuffing are added to obtain a mixture; the mixture is stirred well, and coated on the non-woven fabric with a thickness of 0.4 mm, where the weight is 500 g/m², the generated power is 0-20, and the generated pressure is 0-3 kg/cm². Then, a subsequent heating treatment is carried out at a temperature 100° C. for 60 min; secondary expansion is avoided; the product size remains stable, and the expansion volume power (the ratio of the volume after expansion to the volume before expansion) is smaller than 0.1%.

### Embodiment 2: Preparation of a Thermal Expansion Compound for Handles

Raw materials: See table 1

Preparation method: The thermosetting resin is added into the diluent, stirred and dissolved; then the foaming agent and the stuffing are added in turn to obtain a mixture; the mixture is stirred well and coated on a glass fiber felt with a thickness of 2 mm. The mixture is coated on the non-woven fabric with a thickness of 2 mm; the weight is 600 g/m²; the generated power is 0-20 times, and the generated pressure is 0-2 kg/cm². Then, a subsequent heating treatment is carried out at a temperature 160° C. for 10 min; secondary expansion is avoided; the product size remains stable, and the expansion volume power (the ratio of the volume after expansion to the volume before expansion) is smaller than 0.1%.

### Embodiment 3: Preparation of a Thermal Expansion Compound for Handles

Raw materials: See table 1

Preparation method: Identical with embodiment 2. A mixture is obtained; a part of the mixture is coated on the glass fiber felt with a thickness of 4 mm; a part of the mixture is coated on the non-woven fabric with a thickness of 4 mm; where, the weight is 200 g/m²; the generated power is 0-20 times, and the generated pressure is 0-12 kg/cm². Then, a subsequent heating treatment is carried out at a temperature 120° C. for 40 min; secondary expansion is avoided; the product size remains stable, and the expansion volume power (the ratio of the volume after expansion to the volume before expansion) is smaller than 0.1%.

### Embodiment 4: Preparation of a Thermal Expansion Compound for Handles

Raw materials: See table 1

Preparation method: Identical with embodiment 2. A mixture is obtained; a part of the mixture is coated on the glass fiber felt with a thickness of 3.5 mm; a part of the mixture is coated on the non-woven fabric with a thickness of 3.5 mm; where, the weight is 1,000 g/m²; the generated power is 0-20 times, and the generated pressure is 0-10 kg/cm². Then, a subsequent heating treatment is carried out at a temperature 140° C. for 20 min; secondary expansion is avoided; the product size remains stable, and the expansion volume power (the ratio of the volume after expansion to the volume before expansion) is smaller than 0.1%.

### Embodiment 5: Preparation of a Thermal Expansion Compound for Handles

Raw materials: See table 1

Preparation method: Identical with embodiment 2. A mixture is obtained; a part of the mixture is coated on the glass fiber felt with a thickness of 5 mm; a part of the mixture is coated on the non-woven fabric at a thickness of 5 mm; where, the weight is 550 g/m²; the generated power is 0-20, and the generated pressure is 0-8 kg/cm². Then subsequent heating treatment is carried out at a temperature 150° C. for 20min; secondary expansion is avoided; the product size remains stable, and the expansion volume power (the ratio of the volume after expansion to the volume before expansion) is smaller than 0.1%.

### Embodiment 6: Preparation of a Thermal Expansion Compound for Handles

Raw materials: See table 1

Preparation method: Identical with embodiment 2. A mixture is obtained; a part of the mixture is coated on the glass fiber felt with a thickness of 10 mm; a part of the mixture is coated on the non-woven fabric with a thickness of 10 mm; where, the weight is 900 g/m²; the generated power is 0-20, and the generated pressure is 0-5 kg/cm². Subsequent heating treatment is carried out at a temperature 110° C. for 50 min; secondary expansion is avoided; the product size remains stable, and the expansion volume power (the ratio of the volume after expansion to the volume before expansion) is smaller than 0.1%.

For the following embodiments, refer to the process flow of the sole FIGURE.

### Embodiment 7: Preparation of Badminton Racket Handles

Badminton racket products are coiled according to the specifications of a structural design, placed on a 80° C. heating platform, preheated for 3 min and pre-formed, and handles of tennis rackets are wrapped with the 0.4 mm thick thermal expansion compound for handles obtained in Embodiment 1. Then, the pre-formed products are placed in a 75° C. pre-heating oven and pre-heated for 3 min, taken out and placed in a molding die. Next, the die is closed and fastened. The die is sent into a 180° C. hot pressing and molding platform, and then treated for 10 min at an external pressure of 120 kg/cm² and an internal pressure of 5 kg/cm². Then, the die is cooled on the cooling platform at a temperature of 15° C. for 10min, where the cooling external pressure is 90 kg/cm²; after forming and de-molding, the appearance is intact; the obtained product is heated at a temperature of 100° C. for 30 min, where the expansion volume power is 0.01%, and the hardness is SHORE D 81.

### Embodiment 8: Preparation of Tennis Racket Handles

Tennis racket products are coiled according to the specifications of a structural design, placed on a 60° C. heating platform, preheated for 10 min and pre-formed, and handles of tennis rackets are wrapped with a 2 mm thick thermal expansion compound for handles obtained in Embodiment 2. Then, the pre-formed products are placed in a 60° C. pre-heating oven and pre-heated for 5 min, taken out and placed in a molding die. Next, the die is closed and fastened. The die is sent into a 150° C. hot pressing and molding platform, and then treated for 17 min at an external pressure of 100 kg/cm² and an internal pressure of 10-12 kg/cm². Then, the die is cooled at the cooling platform at a temperature of 30° C. for 4 min, where the cooling external pressure is 70 kg/cm²; after forming and de-molding, the appearance is intact; the obtained product is heated at a temperature of 120° C. for 30 min, where the expansion volume power is 0.09%, and the hardness is SHORE D 90.

### Embodiment 9: Preparation of Clubs and Racket Handles

Tennis racket products are coiled according to the specifications of a structural design, placed on a 25° C. heating platform, preheated for 60 min and pre-formed, and then pre-forming clubs and ball bats are wrapped with a cycle of 5 mm thick thermal expansion compound for handles obtained in Embodiment 5. Then, the pre-formed products are placed in a 35° C. pre-heating oven and pre-heated for 60 min, taken out and placed in a molding die. Next, the die is closed and fastened. The die is sent into an 80° C. hot pressing and molding platform, and then treated for 120 min at an external pressure of 80 kg/cm² and an internal pressure of 15 kg/cm². Then, the die is cooled at the cooling platform at a temperature of 45° C. for 3min, where the cooling external pressure is 105 kg/cm²; after forming and de-molding, the appearance is intact; the obtained product is heated at a temperature of 160° C. for 60 min, where the expansion volume power is 0.09%, and the hardness is SHORE D 90.

The Embodiments of the disclosure are shown and described above, but it should be understood that the above Embodiments are used as examples and cannot be regarded as the limit in the disclosure. Those ordinarily skilled in the art can make changes, amendments, replacement and modifications on the above embodiments within the scope of the disclosure.

What is claimed is:

1. A thermal expansion compound for handles, wherein thermal expansion compound for handles is prepared from the following ingredients by weight part:
thermosetting resin: 20-80;
foaming agent: 5-50;
stuffing: 5-50;
diluent: 0-60.

2. The thermal expansion compound for handles according to claim 1, wherein the thermal expansion compound for handles is prepared from the following ingredients by weight part:
thermosetting resin: 30-50;
foaming agent: 20-40;
stuffing: 10-30;
diluent: 0-30.

3. The thermal expansion compound for handles according to claim 1, wherein the thermosetting resin is high-Tg thermosetting resin at a temperature within the range of 120-350° C.

4. The thermal expansion compound for handles according to claim 1, wherein an expansion temperature of the foaming agent is within the range of 50-180° C.

5. The thermal expansion compound for handles according to claim 1, wherein the stuffing is carbon fiber powder, graphite powder, carbon nano-tube, aluminum oxide, magnesium oxide, calcium carbonate, or talcum powder.

6. The thermal expansion compound for handles according to claim 1, wherein the diluent is a reaction-type diluent or non-reaction-type diluent;
preferably, the reaction-type diluent is butyl glycidyl ether, phenyl glycidyl ether, C12-14 aliphatic polyalcohol glycidyl ether, or 1,4-butanediol diglycidyl ether;
and the non-reaction-type diluent is acetone, butanone, xylene, ethyl acetate, or butyl acetate.

7. The thermal expansion compound for handles according to claim 1, wherein the thickness of the thermal expansion compound for handles is 0.4-10 mm, preferably 2-5 mm.

8. The thermal expansion compound for handles according to claim 1, wherein a preparation method comprises the following steps: adding the thermosetting resin into the diluent, blending the mixed materials, adding the foaming agent and the stuffing in turn to obtain a mixture, stirring the mixture well, coating the mixture on a backing material; or heating the thermosetting resin until the temperature exceeds a softening temperature, adding the foaming agent and the stuffing to obtain a mixture, stirring the mixture well, and coating the mixture on a backing material; wherein a proper drying method is adopted according to the existence of a solvent, and cutting dimensions depend on the actual situations;
preferably, the backing material is non-woven fabric, glass fiber felt, pearl cotton or cotton cloth.

9. Applications of the thermal expansion compound for handles according to claim 1, wherein handles are preferably handles of tennis rackets, badminton rackets, squash rackets, PK rackets, beach rackets, flexible rackets, ball bats and clubs.

10. Applications according to claim 9, wherein a process adopted for preparing handles comprises the following procedures:
designing specifications and dimensions according to respective structures of sports instruments, cutting a piece of fiber composite fabric and the thermal expansion compound for handles, sorting the cut pieces for later use;
coiling: coiling a fiber composite fabric according to the structure of a specific sports instrument;
pre-molding: placing the coiled fabric on a heating platform at a temperature within the range of room temperature −80° C., pre-heating the coiled fabric for 3-60 min, extruding the coiled fabric to remove gases among layers as much as possible, flattening the coiled fabric, cutting the thermal expansion compound to an appropriate size and wrapping cut pieces around a handle of the instrument, then placing the wrapped product in a pre-forming die, and pre-forming the wrapped product into a pre-designed shape of the pre-forming die;
molding: placing the pre-formed product into a pre-heating oven, pre-heating the pre-formed product to a temperature of 35-75° C. for 3-60 min, then taking out the preheated product, placing the preheated product into a molding die, closing a die cover; sending the die into a hot pressing molding platform, heating the thermal expansion compound for handles by the effect of a heating program such that the thermal expansion compound expands and then handle molding is completed, wherein preferably, the heating program includes the following parameters:
80-180° C. heating temperature, 10-120 min heating time, 80-120 kg/cm² external pressure and 5-15 kg/cm² internal pressure;
cooling and de-molding: sending the die into a cooling platform after molding, cooling the molding die, sending the cooled molding die into a de-molding platform, opening the die and taking out the finished product, wherein preferably, the cooling program includes the following parameters: 15-45° C. cooling temperature, 3-10 min cooling time, 70-105 kg/cm² and external cooling pressure.
